(19) United States
(12) Patent Application Publication
(10) Pub. No.: US 2012/0142823 A1
(43) Pub. Date: Jun. 7, 2012

(54) TRANSLUCENT AND OPAQUE IMPACT MODIFIERS FOR POLYLACTIC ACID

(76) Inventors: Zuzanna Cygan, Wayne, PA (US); Jeffrey Brake, Newark (DE)

(21) Appl. No.: 12/515,640

(22) PCT Filed: Nov. 13, 2007
(86) PCT No.: PCT/US2007/084502

§ 371 Date: Dec. 21, 2011

Related U.S. Application Data
(60) Provisional application No. 60/860,375, filed on Nov. 21, 2006.

(51) Int. Cl. C08L 67/04

(52) U.S. Cl. 524/35; 525/186; 524/53; 524/52; 524/27; 525/92 L

(57) ABSTRACT

The invention relates to a blend of one or more biodegradable polymers with one or more impact modifiers, for the purpose of improving the impact properties of the biodegradable polymer(s). The biodegradable polymer is preferably a polylactide or polyhydroxy butyrate. The composition comprises 30-99.9 weight percent of degradable polymer and 0.1 to 15 weight percent of one or more impact modifiers. Haze levels can be controlled by the composition and percentage of impact modifier (or modifiers) selected, to produce a polymer composition having an appearance ranging from translucent to opaque.

### FIELD OF THE INVENTION

The invention relates to a blend of one or more biodegradable polymers with one or more impact modifiers, for the purpose of improving the impact properties of the biodegradable polymer(s). The biodegradable polymer is preferably a polylactide or polyhydroxy butyrate. The composition comprises 30-99.9 weight percent of a degradable polymer and 0.1 to 15 weight percent of one or more impact modifiers. Haze levels can be controlled by the composition and percentage of impact modifier (or modifiers) selected, to produce a polymer composition having an appearance ranging from translucent to opaque.

### BACKGROUND OF THE INVENTION

The growing global concern over persistent plastic waste has generated much interest in biodegradable polymers for everyday use. Biodegradable polymers based on polylactic acid (PLA) are one of the most attractive candidates as they can be readily produced from renewal agricultural sources such as corn. Recent developments in the manufacturing of the polymer economically from agricultural sources have accelerated the polymers emergence into the biodegradable plastic commodity market.

Linear acrylic copolymers have been disclosed for use as process aids in a blend with a biopolymer, such as polylactide. (U.S. Application 60/841,644). The disclosed linear acrylic copolymers do not provide satisfactory impact properties. Additives such as impact modifiers could be used in the polylactide composition.

One problem with many biodegradable polymers, such as polylactide, is the very brittle nature of the pure polymer. This property results in very low impact properties of finished articles, much lower than what is desirable for adequate product performance.

Impact modifiers such as methylmethacrylate-butadiene-styrene (MBS) and acrylic core-shell or block copolymers have been used in PVC and polycarbonate blends.

It has been found that the addition of certain impact modifiers to a biodegradable polymer provides substantial improvements in Gardner impact properties, and also provides an opaque or translucent appearence in the polymer (generates low to high levels of haze). The level of haze can be controlled using the proper balance of impact modifier (or blends of impact modifiers) and biopolymer.

### SUMMARY OF THE INVENTION

The invention relates to a biodegradable composition comprising:
a) 30 to 99.9 weight percent of one or more biodegradable polymers;
b) 0-69.9 weight percent of one or more biopolymer; and
c) 0.1 to 15 weight percent of one or more impact modifiers.
   The invention also relates to a method for controlling the level of haze in an impact-modified biodegradable polymer composition by adjusting the composition and weight percentage of one or more impact modifiers.

### DETAILED DESCRIPTION OF THE INVENTION

The invention relates to blends of one or more biodegradable polymer with impact modifiers to produce a composition having very good impact properties as well as a low to high haze.

The biodegradable polymer of the invention can be a single biodegradable polymer, or a mixture of biodegradable polymers. Some examples of biodegradable polymers useful in the invention include, but are not limited to, polylactide and polyhydroxy butyrate. The biodegradable composition comprises 30 to 99.9 weight percent of the one or more biodegradable polymers.

The preferred polylactide and polyhydroxy butyrate can be a normal or low molecular weight.

In addition to the biodegradable polymer(s), other bio-polymers, such as, but not limited to starch, cellulose, and polysaccharides may also be present. Additional biopolymers, such as but not limited to polycaprolactam, polyamide 11 and aliphatic or aromatic polyesters may also be present. The other bio-polymers may be present in the composition at from 0-69.9 weight percent.

One or more impact modifiers is used at from 0.1 to 15 weight percent of the composition. The impact modifier can be a linear block copolymer, terpolymer, or tetramer; or a core/shell impact modifier. Useful linear block copolymers include, but are not limited to, acrylic block copolymers, and SBM-type (styrene, butadiene, methacrylate) block polymers. The block copolymers consists of at least one “hard” block, and at least one “soft” block. The hard blocks generally have a glass transition temperature (Tg) of greater than 20° C., and more preferably greater than 50° C. The hard block can be chosen from any thermopolymer meeting the Tg requirements. Preferably, the hard block is composed primarily of methacrylate ester units, styrenic units, or a mixture thereof.

The soft blocks generally have a Tg of less than 20° C., and preferably less than 0° C. Preferred soft blocks include polymers and copolymers of alkyl acrylates, dienes, styrenics, and mixtures thereof. Preferably the soft block is composed mainly of acrylate ester units or dienes.

“Acrylic copolymers” as used herein, refers to copolymers having 60 percent or more of acrylic and/or methacrylic monomer units. “(meth) acrylate” is used herein to include both the acrylate, methacrylate or a mixture of both the acrylate and methacrylate. Useful acrylic monomers include, but are not limited to methyl (meth)acrylate, ethyl (meth)acrylate, n-propyl (meth)acrylate, isopropyl (meth)acrylate, n-butyl (meth)acrylate, isobutyl (meth)acrylate, sec-butyl (meth)acrylate, tert-butyl (meth)acrylate, amyl (meth)acrylate, isoamyl (meth)acrylate, n-hexyl (meth)acrylate, cycloheyl (meth)acrylate, 2-ethylhexyl (meth)acrylate, pentadecyl (meth)acrylate, dodecyl (meth)acrylate, isobornyl (meth)acrylate, phenyl (meth)acrylate, benzyl (meth)acrylate, phnoxyethyl (meth)acrylate, 2-hydroxyethyl (meth)acrylate and 2-methoxyethyl (meth)acrylate. Preferred acrylic monomers include methyl acrylate, ethyl acrylate, butyl acrylate, and 2-ethyl-hexyl-acrylate, methyl methacrylate, ethyl methacrylate, and butyl methacrylate.

In principle, any living or controlled polymerization technique can be utilized to make the block copolymer. However, for the practicality of controlling acrylics, the block copolymers of the present invention are preferably formed by controlled radical polymerization (CRP). These processes generally combine a typical free-radical initiator with a compound to control the polymerization process and produce polymers of a specific composition, and having a controlled molecular weight and narrow molecular weight range. These free-radical initiators used may be those known in the art, including, but not limited to peroxy compounds, peroxides, hydroperoxides and azo compounds which decompose thermally to provide free radicals. In one embodiment the initiator may also contain the control agent.

Examples of controlled radical polymerization techniques will be evident to those skilled in the art, and include, but are not limited to, atom transfer radical polymerization (ATRP), reversible addition fragmentation chain transfer polymerization (RAFT), nitroxide-mediated polymerization (NMP), boron-mediated polymerization, and catalytic chain transfer polymerization (CCT).

One preferred method of controlled radical polymerization is nitroxide-mediated CRP. Nitroxide-mediated polymerization can occur in bulk, solvent, and aqueous polymerization, can be used in existing equipment at reaction times and temperature similar to other free radical polymerizations. One advantage of nitroxide-mediated CRP is that the nitroxide is generally innocuous and can remain in the reaction mix, while other CRP techniques require the removal of the control compounds from the final polymer.

The core-shell (multi-layer) impact modifiers could have a soft (rubber or elastomer) core and a hard shell, a hard core covered with a soft elastomer-layer, and a hard shell, of other core-shell morphology known in the art. The rubber layers are composed of low glass transition (Tg) polymers, including, but not limited to, butyl acrylate (BA), ethylhexyl acrylate (EHA), butadiene (BD), butylacrylate/styrene, and many other combinations.

The preferred glass transition temperature (Tg) of the elastomeric layer should be below 25° C. The elastomeric or rubber layer is normally crosslinked by a multifunctional monomer for improved energy absorption. Crosslinking monomers suitable for use as the crosslinker in the core/shell impact modifier are well known to those skilled in the art, and are generally monomers copolymerizable with the monounsaturated monomer present, and having ethylenically multifunctional groups that have approximately equal reactivity. Examples include, but are not limited to, divinylbenzene, glycol of di- and trimethacrylates and acrylates, triol triacrylates, methacrylates, and allyl methacrylates, etc. A grafting monomer is also used to enhance the interlayer grafting of impact modifiers and the matrix/modifier particle grafting. The grafting monomers can be any polyfunctional crosslinking monomers.

For soft core multi-layered impact modifies, the core ranges from 30 to 85 percent by weight of the impact modifier, and outer shells range from 15-70 weight percent. The crosslinker in the elastomeric layer ranges from 0 to 5.0%. The synthesis of core-shell impact modifiers is well known in the art, and there are many references, for example U.S. Pat. No. 3,793,402, U.S. Pat. No. 3,808,180, U.S. Pat. No. 3,971,835, and U.S. Pat. No. 3,671,610, incorporated herein by reference. The refractive index of the modifier particles, and/or matrix polymer, can be matched against each other by using copolymerizable monomers with different refractive indices. Preferred monomers include, but are not limited to, styrene, alpha methylstyrene, and vinylidene fluoride monomers having unsaturated ethylenic group.

Other non-core/shell impact modifiers are also possible for use in this invention, where super transparency and clarity may not be required. For example butadiene rubber can be incorporated into an acrylic matrix to achieve high ballistic resistance property.

A preferred MBS type core/shell polymer is one having a 70-85% core of 80-100 weight % butadiene and 0-20% styrene, and a shell comprised of 75-100 weight % methyl methacrylate, 0-20 weight percent butyl acrylate and 0-25 weight percent ethyl acrylate.

In one embodiment, the acrylic copolymer impact modifier is an acrylate based copolymer with a core-shell polymer having a rubbery core, such as 1,3-dienes (also copolymers with vinyl aromatics) or alkyl acrylates with alkyl group containing 4 or more carbons and the shell is grafted onto the core and is comprised of monomers such as vinyl aromatics (e.g., styrene), alkyl methacrylates (alkyl group having 1-4 carbons), alkyl acrylates (alkyl group having 1-4 carbons), and acrylonitrile.

A preferred acrylic type core/shell polymer is one having a 70-85% core of 0-75 weight % butylacrylate, 10-100% 2-ethylhexyl acrylate and 0-35% butadiene, and a shell comprised of 75-100 weight % methyl methacrylate, 0-20 weight percent butyl acrylate and 0-25 weight percent ethyl acrylate.

The biodegradable polymer composition of the invention contains 30-99.9 weight percent of the biodegradable polymer, 0-69.9 weight percent of other biopolymers and from 0.1-15 weight percent of the acrylic copolymer(s). The ingredients may be admixed prior to processing, or may be combined during one or more processing steps, such as a melt-blending operation. This can be done, for instance by single-screw extrusion, twin-screw extrusion, Buss kneader, two-roll mill, impeller mixing. Any admixing operation resulting in a homogeneous distribution of acrylic-methacrylic copolymer in the biodegradable polymer is acceptable. Formation of the blend is not limited to a single-step formation. Masterbatch formation of 15-99% acrylic-methacrylic copolymer in 1-85% carrier polymer followed by subsequent addition to the biodegradable polymer to derive a final blend is also anticipated. The carrier polymer may be, but is not limited to, polylactide, acrylic-methacrylic copolymers, and methacrylic homopolymers.

In addition to the biodegradable polymer, biopolymer and impact modifier adding up to 100 percent, the composition of the invention may additionally contain a variety of additives, including but not limited to, heat stabilizers, internal and external lubricants, other impact modifiers, process aids, melt strength additives, fillers, and pigments.

The composition of the invention was found to have greatly improved the impact properties of the polylactide alone.

The impact-modified biodegradable polymer composition can range from almost clear or translucent, to opaque, depending on the composition and level of impact modification. The acrylic polymers tend to produce a lower level of haze, leading to a more translucent character, while use of MBS-type impact modifiers produce a higher level of haze, and lead to a more opaque composition. By using the information of the invention, one in the art can control the translucency/opaqueness of the final composition.

The composition of the invention can be processed using any known method, including but not limited to injection molding, extrusion, calendaring, blow molding, foaming and thermoforming. Useful articles that can be made using the biodegradable composition, include but are not limited to packaging materials, films and bottles. One in the art can imagine a variety of other useful articles and processes for forming those articles, based on the disclosure and examples herein.

### Example 1

A blend of 90-99% polylactide containing 1-10% by weight of an MBS based modifier was formed by melt extrusion using a twin-screw extruder. The processing temperature and melt temperature during extrusion were maintained above the melting temperature of polylactide (>152° C.) to ensure a homogeneous melt. The extrudate was pelletized and processed either via injection molded. Injection molding was performed with a nozzle temperature above polylactide melting temperature (>152° C.) and the mold temperature was maintained below polylactide glass transition temperature (<50° C.). A single-cavity disc was used to make 41 mil thick disks. Haze measurements were performed on the disks using a Colormeter and dart drop impact measurements were performed with a Gardner Impact tester with a 8 lb hemispherical impactor head. The following data was observed:

| Wt % impact | | Error in haze | Impact | Error in impact |
|---|---|---|---|---|
| modifier | Haze | measurement | [in lbs] | measurement |
| 2.0 | 78.2 | 0.1 | 12.00 | 0.38 |
| 5.0 | 86.9 | 0.0 | 19.11 | 1.66 |
| 7.0 | 87.4 | 0.1 | 34.40 | 7.63 |
| 10.0 | 87.6 | 0.2 | 96.80 | 8.67 |

Control samples of PLA without any impact modifier had haze values below 4 and fell well below the lower limit of the test instrument, 8 in lbs.

### Examples 2

A blend of 90-99% polylactide containing 1-10% by weight of acrylic-methacrylic copolymer impact modifier was formed by melt extrusion using a twin-screw extruder. The processing temperature and melt temperature during extrusion were maintained above the melting temperature of polylactide (>152° C.) to ensure a homogeneous melt. The extrudate was pelletized and processed either via injection molded. Injection molding was performed with a nozzle temperature above polylactide melting temperature (>152° C.) and the mold temperature was maintained below polylactide glass transition temperature (<50° C.). A single-cavity disc was used to make 41 mil thick disks. Haze measurements were performed on the disks using a Colormeter and dart drop impact measurements were performed with a Gardner Impact tester with a 8 lb hemispherical impactor head. The following data was observed:

| Wt % impact | | Error in haze | Impact | Error in impact |
|---|---|---|---|---|
| modifier | Haze | measurement | [in lbs] | measurement |
| 2.0 | 24.6 | 0.5 | 12.00 | 0.38 |
| 5.0 | 45.0 | 1.8 | 13.60 | 2.45 |
| 7.0 | 54.2 | 0.9 | 23.20 | 3.49 |
| 10.0 | 61.7 | 1.1 | 74.40 | 7.63 |

Control samples of PLA without any impact modifier had haze values below 4 and fell well below the lower limit of the test instrument, 8 in lbs.

1. A caustic-resistant membrane comprising a homogeneous polymer blend comprising:
a) 50 to 99 percent by weight of at least one polyvinylidene fluoride (PVDF) polymer or copolymer; and
b) 1 to 50 percent by weight of at least one acrylic polymer.

2. The membrane of claim 1 wherein said miscible polymer blend comprises:
a) 75 to 90 percent by weight of at least one polyvinylidene fluoride polymer; and
b) 10 to 25 percent by weight of at least one acrylic polymer.

3. The membrane of claim 1 wherein said PVDF polymer comprises a copolymer of 85-95 mole percent of polyvinylidene fluoride and 5 to 15 mole percent of hexafluoropropylene.

4. The membrane of claim 1 wherein said PVDF polymer has a molecular weight of from 100,000 to 5,000,000 g/mol.

5. The membrane of claim 1 wherein said acrylic polymer is a copolymer comprising from 50 to 100 weight percent of methyl methacrylate monomer units.

6. The membrane of claim 5 wherein said acrylic polymer is a copolymer comprising from 70 to 100 weight percent of methyl methacrylate monomer units.

7. The membrane of claim 1 wherein said acrylic polymer comprises a copolymer having from 70 to 99 weight percent of methyl methacrylate units and from 1 to 30 weight percent of one or more C₁₋₄ alkyl acrylates.

8. The membrane of claim 1 wherein said acrylic polymer comprises from 0.5 to 10 weight percent of (meth)acrylic acid

9. The membrane of claim 1 wherein said acrylic polymer comprises a copolymer having from 60 to 99 weight percent of methyl methacrylate units, from 1 to 20 weight percent of one or more C₁₋₄ alkyl (meth)acrylates, and/or from 1 to 20 weight percent C₁₋₄ (meth)alkyl-acrylic acids.

10. The membrane of claim 1 wherein said acrylic polymer has a molecular weight of from 30,000 to 500,000 g/mol.

11. The membrane of claim 1, wherein said acrylic polymer comprises an acrylic block copolymer.

12. The membrane of claim 12, wherein said acrylic block copolymer is a triblock copolymer having a polybutyl acrylate center block and methylmethacrylate or methylmethacrylate copolymers as end blocks.

13. The membrane of claim 1, wherein the PVDF and acrylic polymer resins are pre-blended, in the appropriate ratio, by melt extrusion into a pelletized form and then subsequently used in the membrane preparation.

14. The membrane according to claim 1, wherein the PVDF and acrylic polymer resins are pre-blended, in the appropriate ratio, by melt extrusion into a pelletized form and then ground into a powder form, which is subsequently used in the membrane preparation.

15. The membrane according to claim 1, wherein the PVDF and acrylic polymer resins are pre-blended as separate powders to give a powder blend of uniform consistency in the appropriate ratio for use in the membrane formulation.

16. The membrane of claim 1, further comprising one or more additives, wherein the PVDF and acrylic polymer resins, along with said additives are pre-blended, in the appropriate ratios, by melt extrusion into a pelletized form and then subsequently used in the membrane preparation.

17. The membrane of claim 16, wherein said additives are selected from the group consisting of polyalkylene glycols, poly-vinylpyrrolidone, metallic salts, and other water extractable pore forming agents.

18. The membrane of claim 1, wherein said membrane is a hollow fiber membrane, a supported hollow fiber membrane, a flat unsupported membrane, or a flat supported membrane.

19. The membrane of claim 1 comprising an article for water purification, purification of biological fluids, wastewater treatment, osmotic distillation, and process fluid filtration.
